(19) United States
(12) Patent Application Publication
(10) Pub. No.: US 2007/0057015 A1
(43) Pub. Date: Mar. 15, 2007

(54) Tapered friction stir welding and processing tool

(76) Inventor: Kevin Colligan, Harvest, AL (US)

Correspondence Address: BUCHANAN INGERSOLL & ROONEY PC, P.O. BOX 1404, ALEXANDRIA, VA, 22313-1404, US

(21) Appl. No.: 11/222,537

(22) Filed: Sep. 9, 2005

(51) Int. Cl. B23K 20/12; B23K 37/00

(52) U.S. Cl. 228/2.1

(57) ABSTRACT

A friction stir welding tool is provided for joining together workpieces utilizing friction stir welding processes having convex- or concave-shaped tapered shoulders. The inventive tool includes a support body rotatable about a first axis and having a distal end defining a shoulder. A rotatable pin extends from the distal end of the support body downward and away from the shoulder. The shoulder of the support body includes at least one section that is tapered, with the taper extending downward toward the pin. In a second embodiment, the pin of the tool has been removed to provide a friction stir surface processing function, and includes tools having either straight, convex-shaped or concave-shaped tapered shoulders.

### FIELD OF THE INVENTION

The present invention is directed generally toward friction stir welding and surface processing and, more particularly, toward improved tools for use in friction stir welding and surface processing processes.

### BACKGROUND OF THE INVENTION

Friction stir welding is a process that makes use of frictional heat, which includes the heat generated between a rotating, non-consumable pin and workpieces, and the heat generated as a result of plastic work from the workpiece material being strained and mixed, to weld the workpieces together. The heat generated softens the workpiece materials and allows the friction stir welding tool to consolidate them to create one piece of material where there were originally two. Friction stir welding is used for joining together various parts of materials, such as metals, plastics, and other materials that will soften and consolidate under frictional heating to become integrally connected. While friction stir welding has been commonly applied to butt joints and corner joints, it can also be applied to lap joints and other types of joints, as well as for eliminating or closing cracks in a given material and for joining together two sides of a material to form a hollow section, such as a tube.

Likewise, friction stir surface processing uses frictional heat to plasticize and stir the surface of a workpiece to form a fine-grained microstructure thereon. Friction stir surface processing can be used for a variety of applications where changing of the microstructure of the surface of a material is desirable. Typically, friction stir surface processing is applied to a single workpiece, rather than for purposes of joining two workpieces together.

Prior art friction stir welding tools are shown in U.S. Patent 6,669,075, issued Dec. 30, 2003 to Colligan, and that patent is incorporated herein by reference.

A prior art apparatus for friction stir welding is shown generally in FIG. 1. Apparatus 10 is rotatable about axis 12, and includes support body 14 and non-consumable pin 16 extending from a distal end of support body 14. As shown in FIG. 1, two workpieces to be welded together, 18 and 20, are aligned so that the edges of the workpieces are held in direct contact at interface 22. As rotating apparatus 10 is brought into contact with interface 22 between workpieces 18 and 20, rotating pin 16 is forced into contact with the material of both workpieces, as shown in FIG. 1.

Pin 16 is inserted into the material of workpieces 18 and 20 until flat shoulder 24 at the distal end of support body 14 contacts the upper surface of workpieces 18 and 20. As apparatus 10 is moved through the material, the rotation of pin 16 in the material and the rubbing of flat shoulder 24 against the upper surface of the workpieces, as well as the resultant plastic work from the workpiece material being strained and mixed, produces a large amount of frictional heat in the vicinity of interface 22. This frictional heat softens the material of the workpieces in the vicinity of rotating pin 16 and shoulder 24 creating a plasticized region and causing commingling of the material which, upon cooling and hardening, forms a weld 26. As apparatus 10 is moved longitudinally along interface 22, weld 26 is formed along interface 22 between the workpieces, thereby joining workpieces 18 and 20 together. Flat shoulder 24 of support body 14 prevents softened material from the workpieces from escaping upward, and forces the material into the plasticized region. When the weld is completed, apparatus 10 is removed.

The '075 patent previously referred to discloses the friction stir welding tool 30 shown in FIG. 2. Friction stir welding tool 30 includes support body 32 rotatable about axis 34, and non-consumable pin 36 attached to support body 32 and extending from end 38 of support body 32. End 38 of support body 32 defines shoulder 40, with pin 36 extending from end 38 of support body 32 downward and away from shoulder 40 in the direction of arrow 41. Typically, support body 32 is circular in cross-section and pin 36 may be centered therein or offset from the center of support body 32.

Prior art tool 30 has tapered shoulder 40, with the taper extending from outer edge 42 of support body 32 downward in the direction of arrow 41 toward pin 36 at angle θ referenced from plane 44 perpendicular to axis 34. Additionally, tapered shoulder 40 includes a plurality of grooves 46 machined into the face of shoulder 40.

Prior art friction stir welding tools require minimal differences in workpiece thickness across the weld joint. Thus, fluctuations in the thickness of the workpieces at their interface may compromise the integrity of the weld formed by friction stir welding processes. Similarly, prior art friction stir welding tools require that the position of the tool be precisely controlled relative to the upper surface of the workpieces in order to generate sufficient frictional heat to adequately plasticize the material. Failure to generate sufficient frictional heat will also compromise the integrity of the weld joint.

Prior art tools also exhibit these deficiencies when use for the purpose of friction stir surface processing, as opposed to friction stir welding.

The present invention is directed toward overcoming one or more of the above-mentioned problems.

### SUMMARY OF THE INVENTION

Improvements of the friction stir welding tools shown in U.S. Pat. No. 6,669,075 patent are disclosed, according to the present invention, for purposes of both friction stir welding and friction stir surface processing.

The inventive friction stir welding tool includes a support body rotatable about an axis and having a distal end defining a shoulder. A rotatable pin extends from the distal end of the support body downward from the shoulder. The shoulder of the support body includes at least one section that is tapered, with the taper extending downward toward the pin, the taper having a convex or concave cross sectional shape. In one form of the present invention, the shoulder has at least one groove formed therein. The groove may include either a spiral formed groove or may be a plurality of concentric grooves formed in the face of the shoulder.

In another form of the present invention, the shoulder includes a substantially flat section and a tapered section having a taper extending downward toward the pin. The substantially flat and tapered sections are concentric and displaced radially from the pin to the outer edge of the support body. The tapered sections have convex or concave cross sectional shapes. Preferably, the substantially flat section is provided adjacent the pin, and the tapered section is provided adjacent the outer edge of the support body.

However, any arrangement of various sections having flat, convex or concave shapes sections may be utilized.

In a second major embodiment of the invention, a friction stir surface processing tool is provided. The friction stir surface processing tool differs from the welding tool in that no pin is provided. Instead, the tapered shoulders of the tool extend downward to form a tip at the center of the far distal end of the tool. The surface of the tapered shoulder defines either a spiral groove or a series of concentric grooves thereon, serving the same purpose as the grooves in the welding tool. In the preferred embodiment, the surface of the tool comprises one tapered section having a convex or concave cross sectional shape, extending from the outer periphery of the tool to a tip defined concentrically with the axis of rotation of the tool. In other embodiments, multiple tapered sections may be provided. The angle of the taper of the shoulder can vary from shallow to steep. In the event that the angle of the taper is steep enough such that the surface of the tapered shoulder can extend all the way through the workpiece, the surface processing tool can also be used for friction stir welding of two workpieces to each other in the same manner as the embodiment of the tool having the center pin.

### BRIEF DESCRIPTION OF THE DRAWINGS

FIG. 1 is a perspective view of a prior art friction stir welding apparatus;

FIG. 2 is a section view of a prior art friction stir welding tool;

FIG. 3 is a section view of a first embodiment of the friction stir welding tool of the present invention, having a tapered shoulder with a convex surface.

FIG. 3a shows the tool of FIG. 3. in situ joining two workpieces together.

FIG. 4 is a section view of a second embodiment of the friction stir welding tool of the present invention, having a tapered shoulder with a concave surface

FIG. 5 is a section view of a first embodiment of a friction stir surface processing tool according to the present invention.

FIG. 5a is a photograph of a workpiece having a dispersion of Ni powder processed using a tapered shoulder tool with a pin.

FIG. 5b is a photograph of a workpiece having a dispersion of Ni powder processed using a tapered shoulder tool without a pin.

FIG. 6 is a section view of a second embodiment of a friction stir surface processing tool according to the present invention, having a more steeply tapered shoulder, rendering it capable of performing friction stir welding on workpieces of appropriate thickness.

FIG. 7 is another embodiment of the friction stir surface processing tool having multiple tapered sections defined on the shoulder.

FIG. 8 is another embodiment of the friction stir surface processing tool of the present invention having a tapered shoulder with a convex surface.

FIG. 9 is yet another embodiment of the friction stir surface processing tool of the present invention having a tapered shoulder with a concave surface.

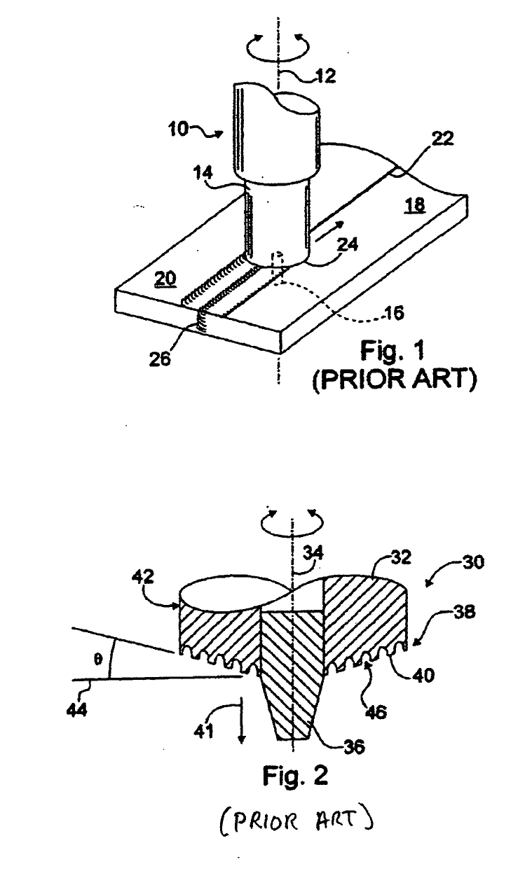

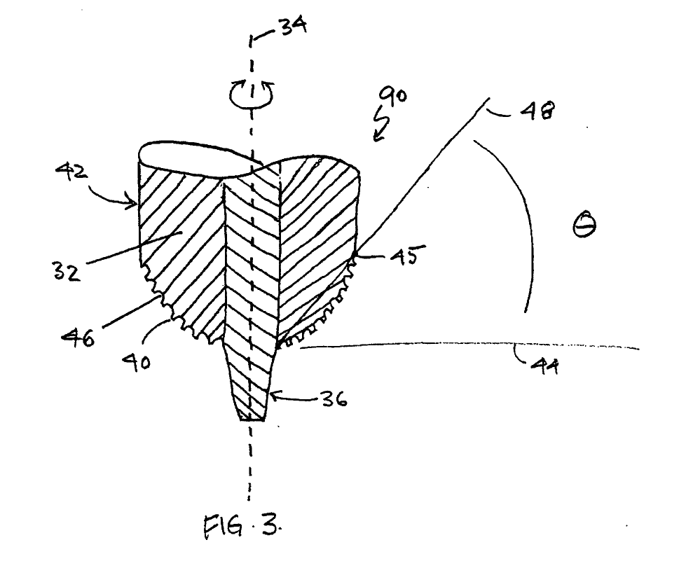

### DETAILED DESCRIPTION OF THE INVENTION

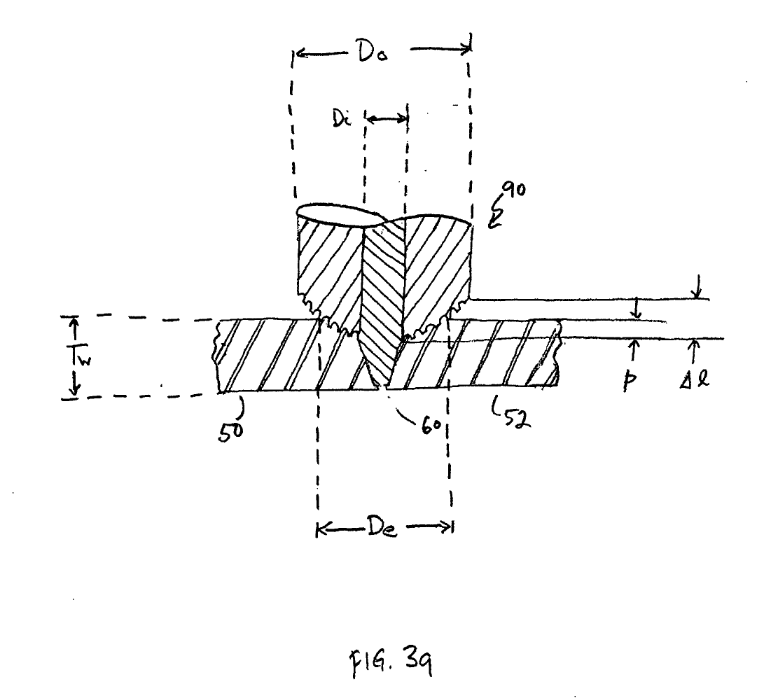

Referring to FIG. 3, a friction stir welding tool according to the present invention is shown generally at 90. Friction stir welding tool 90 includes support body 32 rotatable about axis 34, and non-consumable pin 36 attached to support body 32 and extending from distal end 38 of support body 32. Distal end 38 of support body 32 defines convex-shaped shoulder 40, extending from outer edge 42 of support body 32 downward toward pin 36 at distal end 38 of support body 32. Typically, support body 32 is circular in cross-section and pin 36 is centered therein, such that pin 36 also rotates about axis 34.

However, pin 36 may be offset from the center of the support body 32 without departing from the spirit and scope of the present invention.

As shown in FIG. 3, shoulder 40 has a convex-shaped taper, with the taper extending from an outer edge 42 of the support body 32 downward toward the pin 36 at an angle θ referenced between plane 44 perpendicular to axis 34 and line 48 drawn from the edge of pin 36 through reference point 45 defined on edge 42 of support body 32 at the point where taper 40 begins. Preferably, angle θ will fall in the range of about 5° to about 60°, but angles outside of that range may be useful. Preferably, the convex shape of tapered shoulder 40 forms an arc between the edge of pin 36 and reference point 45 along outer edge 42 of support body 32, having line 48 as a cord thereof. In other embodiments of the invention, the convex shape of tapered shoulder may be less regular, not forming an arc of a circle. Tapered shoulder 40 may include one or more grooves 46 machined into a face of the shoulder 40. Grooves 46 may be machined into the face of shoulder 40 as a spiral formed groove or as a plurality of concentric grooves and, additionally, may be machined normal to the face of the shoulder 40, parallel with pin 36, or at some other orientation. Support body 32 and pin 36 are typically made of a material harder than the workpiece material to be joined

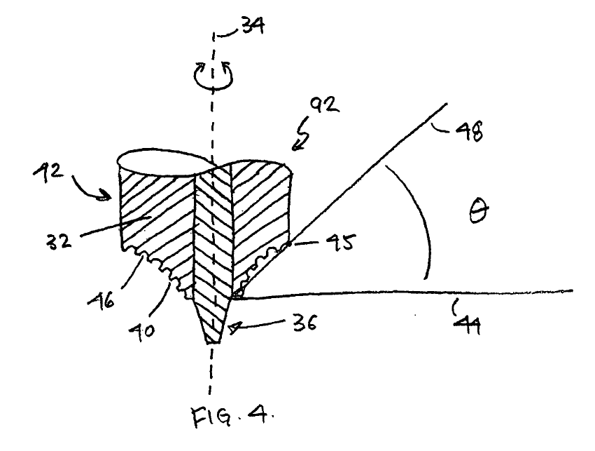

FIG. 4 shows a complimentary embodiment to the embodiment of FIG. 3, wherein tool 92 has a concave-shaped taper 40 instead of a convex-shaped taper.

In use, as shown in FIG. 3a, pin 36 is inserted into a joint region, or interface 60, between two workpieces 50 and 52 to be joined, with shoulder 40 contacting the upper surfaces of the workpieces. Rotation of friction stir welding tool 90 about axis 34 results in the generation of frictional heat, which includes the heat generated between tool 90 (specifically pin 36 and shoulder 40) and workpieces 50 and 52, and the heat generated as a result of plastic work from the workpiece material being strained and mixed, causing workpieces 50 and 52 to become plasticized in a region near interface 60. As tool 90 is translated along interface 60, workpieces 50 and 52 are plasticized and then harden to form a weld, which joins the workpieces together. The friction stir welding process has been utilized to join a wide range of materials, including metals and alloys, reinforced metals such as MMCs (metal matrix composites), and thermoplastic type materials. Friction stir welding is commonly applied to butt joints and corner joints, although the process can be used to join lap joints and other types of joints, as well as for closing cracks in materials.

The tapered shoulder design of inventive tool 90 offers several advantages over prior art friction stir welding tools. First, the inventive design results in tool 90 having a variable effective diameter Dₑ, as shown in FIG. 3a. Prior art friction stir welding tools having a flat shoulder are typically constructed with different fixed shoulder diameters depending on the material thickness, pin diameter, and other factors. However, the tapered and curved shoulder design of tool 90 can produce a variable effective diameter Dₑ simply by changing the depth of penetration of tool 90 into workpieces 50 and 52. Increasing the depth of penetration of tool 90 into workpieces 50 and 52 will increase the effective diameter Dₑ. Similarly, reducing the depth of penetration of tool 90 into workpieces 50 and 52 will reduce the effective diameter Dₑ. This increase or decrease in the effective diameter Dₑ can be done “on the fly” as tool 90 is translated along interface 60 between workpieces 50 and 52. The tool described in patent '075, referenced above, provides a linear variation in effective diameter with depth of penetration, while the present invention provides for non-linear shoulder diameter variation, as is described further below.

Referring still to FIG. 3a, showing welding tool 90 in situ with workpieces 50 and 52, tapered and curved shoulder 40 of welding tool 90 can generate different effective diameters Dₑ based upon various parameters. As shown in FIG. 3a, shoulder 40 has an outer diameter Dₒ, an inner diameter Dᵢ, and an effective diameter Dₑ which is defined by the interface of tapered shoulder 40 and the upper surface of workpieces 50 and 52. During operation, tapered shoulder 40 extends into workpieces 50 and 52 a plunge depth p, has a vertical length Δl, and a taper angle θ, as shown in FIG. 3. Using these parameters, the effective diameter Dₑ of the tapered shoulder 40 can be calculated as follows:
Dₑ=ƒ(p)+Dᵢ (1)
where f(p) defines the profile of the tapered surface with respect to shoulder penetration depth p. If f(p) is a first-order function with respect to p, then the tapered surface is a linear function, as was described in the '075 patent, referred above. If f(p) is of a higher order, then the surface can generally be described as being concave with respect to line 48, and if f(p) is of a lower order, then the surface can generally be described as being convex with respect to line 48. For the first order case, f(p) can be defined as:

$$\begin{matrix}f ( p ) = \frac{2 p}{tan θ} , \\ where , & ( 2 ) \\ tan θ = \frac{Δ l}{\frac{( {D}_{o} - {D}_{i} )}{2}} = \frac{2 Δ l}{( {D}_{o} - {D}_{i} )} & ( 3 )\end{matrix}$$

Then, substituting (3) into (1), we have the relationship between the effective diameter and the shoulder penetration depth for the linear tapered shoulder defined in the '075 patent:

$${D}_{e} = {D}_{i} + 2 \frac{p}{tan θ} \qquad ( 4 )$$

As an example of a higher order profile, a second order profile that is concave with respect to the line 48 can be defined as,
ƒ(p)=p², (5)
which can be substituted into equation (1) to yield,
Dₑ=Dᵢ+p². (6)

As an example of a lower order profile, a profile that is convex with respect to the line 48 can be defined as,
ƒ(p)=\sqrt{p}, (7)
which can be substituted into equation (1) to yield,
Dₑ=Dᵢ+\sqrt{P}. (8)

The present invention provides for greater flexibility in the welding tool design, over and above that provided by the '075 patent. For friction stir welding tool 90 having a linear taper, such as described in the '075 patent, to be able to generate effective welds in workpiece material that has a large variation in plunge depth p without a large change in the effective diameter Dₑ, it would generally be desirable to construct tool 90 with a shoulder 40 having a large vertical taper length Δl. This property can be seen by taking the derivative of the effective diameter Dₑ with respect to plunge depth p:

$$\frac{ⅆ}{ⅆ p} {D}_{e} = \frac{( {D}_{o} - {D}_{i} )}{Δ l} \qquad ( 9 )$$

Typically, inner diameter Dᵢ is fixed by the diameter of pin 36. Thus, to reduce variations in effective diameter Dₑ with respect to plunge depth p, it is evident from Equation 9 that having a large vertical taper length Δl achieves this goal.

However, the goal of having a small variation in effective diameter Dₑ with respect to plunge depth p can be achieved more effectively by using a tool that has a concave profile with respect to line 48. By taking the derivative of the effective diameter, equation (6), with respect to the plunge depth we see that for a second order profile,

$$\frac{ⅆ}{ⅆ p} {D}_{e} = 2 p . \qquad ( 10 )$$

Equation (10) shows that for a second order profile, for a small value of the change in effective diameter with respect to p can be smaller than the first order profile given the same angle θ. The opposite is true for profiles that are convex with respect to line 48.

Herein lies one of the advantages of the present invention over the prior art. The present invention allows for non-linear change in effective diameter with respect to shoulder penetration, giving the tool designer greater flexibility in specifying tools.

A second advantage of the tapered and curved shoulder design is that tool 90 can accommodate variations in material thickness or unplanned variations in plunge depth p (depth of penetration) with little or no change in the quality of the weld, at least as far as the upper portion of the weld is concerned. Typically, with prior art friction stir welding tools, it is extremely important that the spatial relationship between the tool and the surface of the workpieces be maintained within a very small tolerance. If the workpiece material should reduce in thickness along the joint interface, then the shoulder of a conventional friction stir welding tool may lift off of the upper surface of the workpieces, resulting in an immediate and large defect in the resultant weld. On the other hand, if the workpiece thickness increases along the joint interface as a result of normal variations, the leading edge of the shoulder of a conventional welding tool can plunge beneath the surface of the workpieces, producing excess flash and reducing the thickness of the workpieces. However, as can be seen from FIG. 3a, should the thickness T_{w} of workpiece 50 or 52 increase or decrease, tool 90 will simply proceed with a variable effective shoulder diameter Dₑ, depending on the depth of penetration of tool 90 relative to the top surface of workpieces 50 and 52. The effective diameter Dₑ will increase or decrease proportionally with thickness T_{w}, of the workpieces. To ensure proper operation of tool 90, one must only maintain the gap between the end of the pin 36 and the anvil (not shown) and ensure that the length of tapered shoulder 40 is adequate to accommodate any normal variations, or any design variations, in the thickness of workpieces 50 and 52.

A third advantage of the inventive design is the increased flow of plasticized material and the increased frictional heat generated by grooves 46 formed in shoulder 40. Normally, in prior art friction stir welding tools, the scroll grooves are fed only by workpiece material that is “kicked up” by the advancing pin of the welding tool. With the tapered and curved shoulder design of the present invention, the downward taper of shoulder 40 forces workpiece material into advancing grooves 46 over the full effective diameter Dₑ, making the scroll much more effective in stirring workpiece material and in generating frictional heat to plasticize the material, thus forming a better overall weld. While angle θmay virtually be any angle, in the preferred embodiment of the invention, angle θ ranges from about 5° to about 60°. However, other taper angles are contemplated and may be utilized without departing from the spirit and scope of the present invention.

Other tool profiles can be derived from the general tapered, curved shoulder concept. Generally, tool 90 can be configured with various combinations of flat areas, and tapered areas having a variety of differing taper angles. The tapered areas of the shoulder of the tool can be either convex-shaped or concave shaped and still be within the scope of the invention. Additionally, embodiments are contemplated wherein convex-shape and concave-shaped tapers appear on the same tool, either separated by a flat shoulder area or adjacent each other.

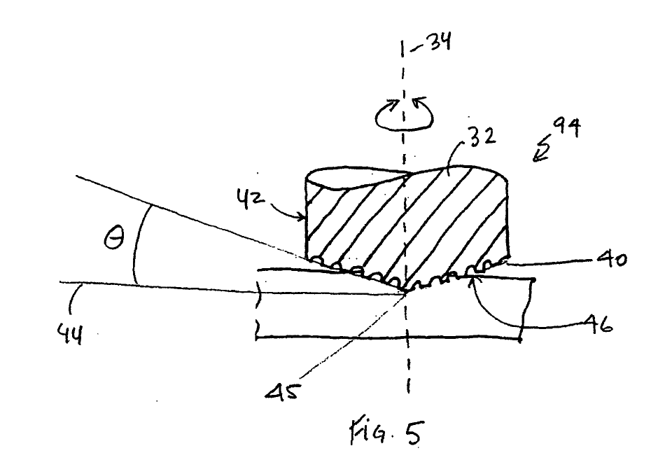

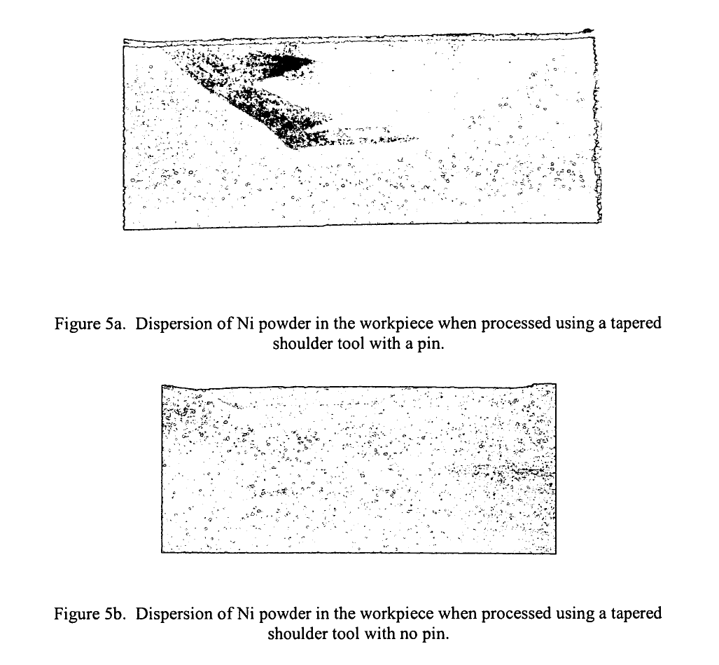

A second embodiment of the invention, suitable for friction stir surface processing, is shown in FIGS. 5-9. FIG. 5 shows tool 94 generally the size and shape of the friction stir welding tool shown in FIG. 3, but without pin 36. In FIG. 5, tapered shoulder 40 of tool 94 extends from center point 45 to outer edge 42 of support body 32. Shoulder 40 may include grooves 46 machined therein, which may be spiral formed or concentric grooves, and which may be machined normal to tapered shoulder 40 as shown in FIG. 5, or normal to the workpiece and generally parallel with axis 34. Grooves 46, defined in tapered shoulder 40, perform the same function as with the embodiments of the invention meant for the stir welding function, that is, directing the plasticized material of the workpiece downward and toward the center of the tool. As with the friction stir welding tool, support body 32 has a generally circular shape and rotates either clockwise or counterclockwise about axis 34.

In operation, friction stir surface processing tool 94 allows the stirring of the surface of a workpiece to some depth below the surface, without pin 36 extending all the way through the workpiece. One advantage of the tapered shoulders in surface processing tool 94 is a tolerance to plunge depth variations relative to the workpiece. Variations in the thickness of the workpiece will result in variations in the width of the weld due to the change in tool plunge depth. Thicker portions in the workpiece will result in a deeper penetration of tool 94 into the surface of the workpiece, and, as a result, the variable effective diameter Dₑ, will increase. Thinner portions will have the opposite effect, that is, Dₑ will decrease.

A second advantage of friction stir surface processing tool 94 arises when the tool is used to embed a material applied to the surface of a workpiece to some depth within the surface of the workpiece. For example, a fine nickel powder can be applied to the surface of a workpiece then stirred using the present invention. The action of the spiral grooves and the shoulder's tapered profile combines to propel the powder down into the surface of the workpiece, where it becomes embedded. An unforeseen benefit of using a tool that has no pin was observed during experiments to characterize the process of friction stir surface processing. In processing runs made using a tool that had a tapered shoulder and a short pin, the pin acted to circulate material in such a way as to result in an inhomogeneous dispersion of the nickel powder in the workpiece, as shown in FIG. 5a. However, when a tool with an identical shoulder profile but no pin was used, a uniform dispersion of nickel particles was created in the surface of the workpiece, as shown in FIG. 5b. Therefore, the method of using an outwardly tapered shoulder with no pin offers particular advantage when used to embed a powder in the surface of the workpiece.

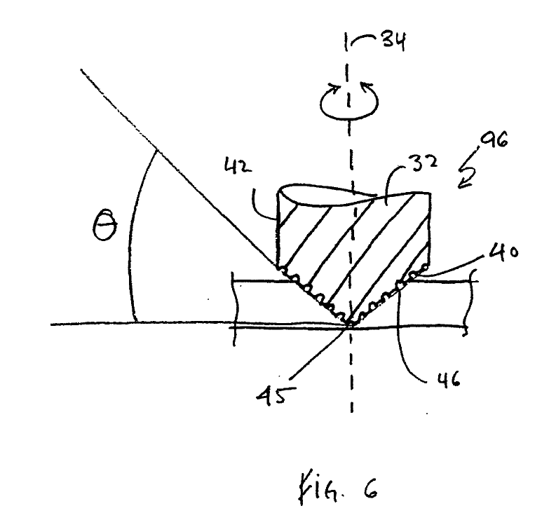

FIG. 6 shows a variation of the tool of FIG. 5, having a steeper angle θ with respect to plane 44 than the embodiment shown in FIG. 5. Changing angle θ of tapered shoulder 40 results in a change in the correlation between the width of the weld and the depth of the weld. Tools 96 having steeper angles θ may actually be used to perform a friction stir welding function as opposed to merely a friction stir surface processing function, if the workpiece is thin enough such that tapered shoulder 40 is able to extend all the way through the workpiece before outer edge 42 of tool 96 contacts the upper surface of the workpiece. While very shallow angles θ for tapered shoulder 40 will produce a large difference in the width of the weld as a function of small changes in the variation of the thickness of the workpiece, higher angles of θ will produce smaller differences in weld width based as a function of small differences in the thickness of the workpiece.

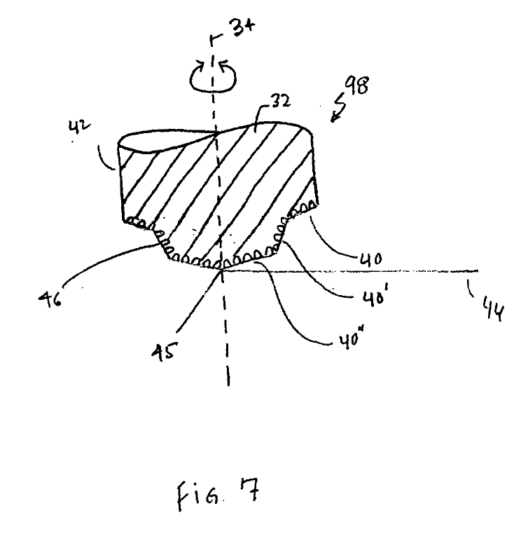

In another embodiment of the friction stir surface processing tool 98, as shown in FIG. 7, the shoulder area of the tool may be configured with multiple sections of tapered shoulder, for example, 40, 40′ and 40″ as shown in FIG. 7, each having different angles with respect to a plane 44 perpendicular to axis 34. In this embodiment, some sections of tapered shoulder 40, 40′ or 40″ may not have grooves defined therein.

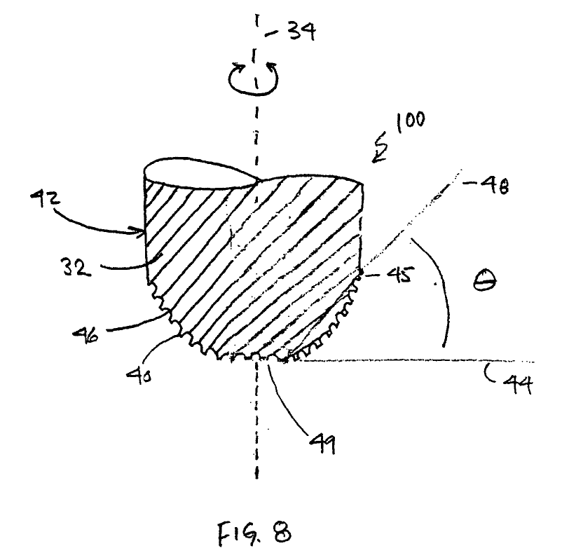

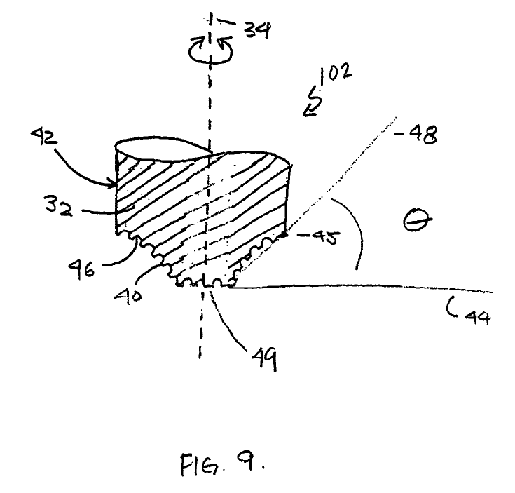

In other embodiments of the friction stir processing tools, taper 40 is convex-shaped, as with tool 100 in FIG. 8, or concave-shaped, as with tool 102 of FIG. 9, corresponding to the friction stir welding tools of FIGS. 3 and 4 respectively, but without pin 36. Taper 40, in this embodiment, extends from the outer edge of flat area 49 to reference point 45 defined on outer edge 42 of support body 32 at an angle θ referenced between plane 44 perpendicular to axis 34 and line 48 drawn from the outer edge of flat area 49 through reference point 45 defined on edge 42 of support body 32 at the point where taper 40 begins. Preferably, angle θ will fall in the range of about 5° to about 60°. Preferably, the convex shape of tapered shoulder 40 forms an arc between the edge of pin 36 and reference point 45 along outer edge 42 of support body 32, having line 48 as a cord thereof, although irregular curves of taper 40 are contemplated to be with the scope of the invention.

While the present invention has been described with particular reference to the drawings, it should be understood that various modifications could be made without departing from the spirit and scope of the present invention.

1. A friction stir surface processing tool comprising:
a body rotatable about an axis;
a shoulders defined on the end of said body, said shoulder being tapered, with the taper extending from an outer edge of said body to a point concentric with said axis; and
one or more grooves defined on said shoulder.

2. The friction stir surface processing tool of claim 1, wherein said one or more grooves is selected from a group consisting of a spiral groove and a plurality of concentric grooves.

3. The friction stir surface processing tool of claim 1, wherein said taper of said shoulder is formed at an angle ranging from 5° to 60° from a plane perpendicular to said axis.

4. The friction stir surface processing tool of claim 1, wherein said one or more grooves are normal to the surface of said shoulder.

5. The friction stir surface processing tool of claim 1, wherein said one or more grooves are parallel to said axis.

6. The friction stir processing tool of claim 3 wherein said tapered shoulder has a convex cross sectional shape.

7. The friction stir processing tool of claim 6 wherein said convex cross section of said tapered shoulder forms an arc of a circle.

8. The friction stir processing tool of claim 3 wherein said tapered shoulder has a concave cross sectional shape.

9. The friction stir processing tool of claim 8 wherein said concave cross section of said tapered shoulder forms an arc of a circle.

10. The friction stir surface processing tool of claim 3 wherein said shoulder includes two or more sections, each having a different angle of taper.

11. The friction stir surface processing tool of claim 10 wherein one or more of said tapered shoulder sections has a convex cross section.

12. The friction stir surface processing tool of claim 10 wherein one or more of said tapered shoulder sections has a concave cross section.

13. The friction stir surface processing tool of claim 10 wherein one or more of said tapered shoulder sections has a cross sectional shape selected from a group comprising a straight line, a convex curve and a concave curve.

14. A friction stir welding tool comprising:
a body rotatable about an axis;
a rotatable pin extending from the end of said body;
a shoulder, defined on the distal end of said body, said shoulder being tapered, with
the taper extending from an outer edge of said body to the outer edge of said pin;
one or more grooves defined on said tapered shoulder;
wherein the surface of said tapered shoulder has a convex or concave curved cross sectional shape.

15. The friction stir welding tool of claim 14 wherein said rotatable pin is concentric with said axis.

16. The friction stir welding tool of claim 15, wherein said taper of said shoulder is formed at an angle ranging from 5° to 60° from a plane perpendicular to said axis.

17. (Canceled)

18. The friction stir welding tool of claim 14, wherein said one or more grooves is selected from a group consisting of a spiral groove and a plurality of concentric grooves.

19. The friction stir welding tool of claim 18, wherein said one or more grooves are normal to the surface of said shoulder.

20. The friction stir welding tool of claim 18, wherein said one or more grooves are parallel to said axis.

21. The friction stir welding tool of claim 14 wherein said shoulder includes two or more sections, each having a different angle of taper.

22. The friction stir welding tool of claim 21 wherein one or more of said tapered shoulder sections has a convex cross sectional shape.

23. The friction stir welding tool of claim 21 wherein one or more of said tapered shoulder sections has a concave cross sectional shape.

24. The friction stir welding tool of claim 21 wherein one or more of said tapered shoulder sections has a cross sectional shape selected from a group comprising a straight line, a convex curve and a concave curve.
